(19) United States
(12) Patent Application Publication
(10) Pub. No.: US 2007/0075145 A1
(43) Pub. Date: Apr. 5, 2007

(54) Jammer for tags and smart cards

(75) Inventor: Anton Petrus Arendonk, Mierio (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Phillips Electronics N.V.

(21) Appl. No.: 10/580,623

(22) PCT Filed: Nov. 24, 2004
(86) PCT No.: PCT/IB04/52525

§ 371 Date: May 24, 2006

(30) Foreign Application Priority Data
Nov. 27, 2003 (EP) 03104423.3

(51) Int. Cl. G06K 19/06; G06K 7/08

(52) U.S. Cl. 235/492; 235/451

(57) ABSTRACT

A jammer (20) for jamming the readout of contactless data carriers (2, 2′) by a reader (1) emitting electromagnetic scanning signals (SS) has an air interface (11) for receiving electromagnetic signals, analyzing means (15) for analyzing the electromagnetic signals received by the air interface, and jamming-signal generating means (18) for generating a jamming signal (DS). The analyzing means (15) for analyzing the electromagnetic signals received are arranged to identify scanning signals (SS) from the reader (1) among the electromagnetic signals received and, when scanning signals (SS) are detected, to transmit a control signal (CS) to the jamming-signal generating means (18), which latter in turn generate the jamming signal (DS) and transmit it via the air interface (11) on receipt of the control signal (CS).

The invention relates to a jammer for jamming the readout of contactless data carriers by a reader emitting electromagnetic scanning signals.

The invention also relates to a container having a jammer in accordance with the invention.

The invention further relates to a data carrier able to be read without physical contact.

Recent developments in the field of contactless (RFID) data carriers relate above all to their miniaturization and to their increased robustness to resist ambient factors. These developments have made it possible for contactless data carriers of this kind, which are also referred to as transponders or tags, to be incorporated in almost any desired substrate materials. In this way, it is known, for example, for contactless data carriers to be incorporated into articles of clothing back at an early stage of the production process in order to enable the operation of manufacturing the articles of clothing and the subsequent wholesaling and retailing involving them to be documented and monitored seamlessly and automatically. Consideration is also being given at central banks to incorporating in banknotes tags that contain a unique note number and, where required, other data such as the time and place of their placing in circulation, in order in this way to enable payment transactions to be monitored more satisfactorily and cases of misuse to be detected more easily. In this way, a tag in each note would, for example, make the production of forged notes considerably more difficult. It would likewise be easier to trace back money originating from criminal activities such as blackmail or movements of illicit cash. However, something that offers benefits from the point of view of security to manufacturers or banks, conversely often jeopardizes the security and privacy of the individual citizen. In this way, a tag incorporated in an article of clothing can of course also be used to monitor the wearer of such an article of clothing. There is likewise a risk with notes having tags integrated into them that thieves will pick out potential victims by, for example, carrying a reader and moving along in a crowd of people, such as in shopping centers or on sidewalks, where they can approach other people unnoticed sufficiently close for the notes carried by these people, and hence the tags integrated into the notes, to come into the zone of action of the reader. In this way, a thief can at least ascertain the number of banknotes that the potential victim is carrying. Depending on the numbering system used for the notes, it may even be possible under certain circumstances for him to determine the value of the notes and thus to deliberately look for victims who are carrying suitably large amounts of money on them.

There is therefore a need for a device to be developed that is able to reduce or even entirely rule out the risks to individual citizens that arise as a result of the implementation of the above monitoring techniques.

It is therefore an object of the invention to provide a jammer of the kind specified in the first paragraph above, a container of the kind specified in the second paragraph above and a data carrier of the kind specified in the third paragraph above in which the disadvantages identified above are avoided. To achieve the above object, features in accordance with the invention are provided in a jammer in accordance with the invention, thus enabling a jammer according to be characterized in the manner specified below, namely:

A jammer for jamming the readout of contactless data carriers by a reader emitting electromagnetic scanning signals, having an air interface for receiving electromagnetic signals, having analyzing means for analyzing the electromagnetic signals received by the air interface, and having jamming-signal generating means for generating a jamming signal, the analyzing means for analyzing the electromagnetic signals received being arranged to identify scanning signals from the reader among the electromagnetic signals received and, when scanning signals are detected, to transmit a control signal to the jamming-signal generating means, the jamming-signal generating means being arranged to generate the jamming signal and transmit it via the air interface on receipt of the control signal.

To achieve the above object, a jammer in accordance with the invention is provided in a container of the above kind.

To achieve the above object, features in accordance with the invention are provided in a data carrier in accordance with the invention, thus enabling a data carrier in accordance with the invention to be characterized in the manner specified below, namely:

A data carrier able to be read without physical contact by a reader emitting electromagnetic scanning signals, having an air interface for receiving electromagnetic signals, having a logic circuit for analyzing the electromagnetic signals received by the air interface and for transmitting items of information, such as an identity number, to the air interface, the air interface being arranged to transmit the items of information received from the logic circuit as electromagnetic identity signals, and having jamming-signal generating means for generating a jamming signal, the logic circuit having a jamming mode of operation in which it identifies scanning signals from the reader among the electromagnetic signals received and, if scanning signals are detected, transmits an activating signal to the jamming-signal generating means, the jamming-signal generating means being arranged to generate the jamming signal and transmit it via the air interface on receipt of the activating signal.

What is achieved by the features in accordance with the invention is that a reader cannot successfully read the data requested from data carriers situated within its zone of action because the data signals emitted by the data carriers have the jamming signals from the jammer in accordance with the invention superimposed on them. Depending on the nature of the data carrier, it too may be affected by the jamming signals from the jammer in accordance with the invention, which means that it may not be able to receive the commands sent by the reader without errors and will therefore not transmit any data whatsoever. Because of the successful prevention of the reception of data by a reader and, where applicable, because of the successful prevention of the transmission of data by data carriers, the personal security of the individual citizen who carries a jammer in accordance with the invention of this kind on him is increased in that he himself cannot be monitored by the contactless requesting of data by a reader, or in that articles that he carries on him that incorporate data carriers able to be read without physical contact can no longer be read by readers.

The measured defined in claim 2 give the advantage that the jammer supplies itself with energy from the high-frequency signals emitted by readers and therefore has an unlimited operating endurance for as long as it is within the zone of action of a reader. Outside the zone of action of readers, the jammer automatically switches itself off again.

The measured defined in claim 3 give the advantage that the jamming signals may be considerably stronger than they are in the case of jammers that obtain their supply of electrical energy from the high-frequency signals from readers. What may also prove particularly advantageous is a combined form of the jammer in accordance with the invention in which the air interface and the means for analyzing the high-frequency signals received are supplied with electrical energy by the high-frequency signals received but other sub-assemblies of the jammer, whose energy consumption is high, are supplied from a battery that, for its part, is switched on and off via an electronic switch—under the control of the means for analyzing the high-frequency signals received.

The measured defined in claims 4 and 12 give the advantage that the jamming signal is not transmitted in every case when the jammer comes within the zone of action of a reader but only when the readers are of selected types. This avoids the problems that might for example arise as a result of the jammer in accordance with the invention interfering with or disabling anti-theft monitoring systems in department stores by emitting jamming signals.

The measured defined in claim 5 give the advantage that a particularly exact division can be made between cases in which the jamming signals are emitted and cases in which they are not.

The measured defined in claims 6, 7, 14 and 15 give the advantage that, due in the respective cases to its high modulation and its high level with a high harmonic content, the jamming signal generated is superimposed on the whole of signals emitted by a data carrier and over a relatively wide band. If required, the scanning signals emitted by the reader can also be blanketed in this way by the jamming signal to such a degree that they are no longer recognized by the data carriers, or are at least rejected as subject to errors, and no data is transmitted by the data carrier.

The measured defined in claim 8 give the advantage that the user of a jammer in accordance with the invention is notified that an attempt to scan has just been made by a reader.

The measured defined in claim 13 give the advantage that the jamming mode of operation of the data carrier can be selectively activated and deactivated from outside, which can for example be done at the request of a user of an article in which the data carrier is incorporated.

These and other aspects of the invention are apparent from and will be elucidated with reference to the embodiments described hereinafter, to which however the invention is not limited.

In the drawings:

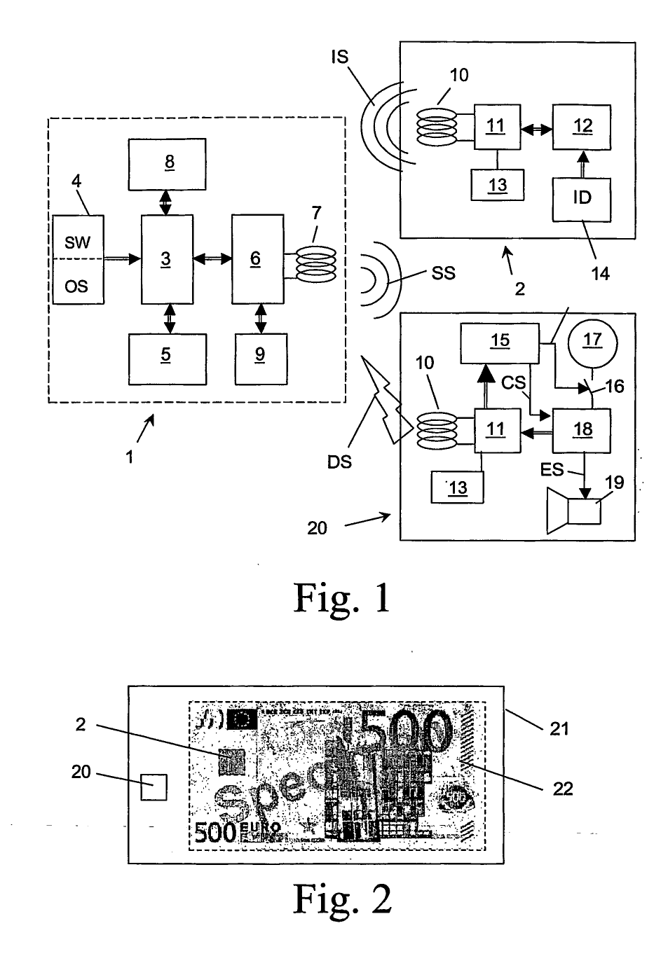

FIG. 1 is a block circuit diagram showing a reader, a contactless data carrier and a jammer in accordance with the invention.

FIG. 2 is a diagram showing a container in the form of a wallet or billfold that is provided with a jammer in accordance with the invention.

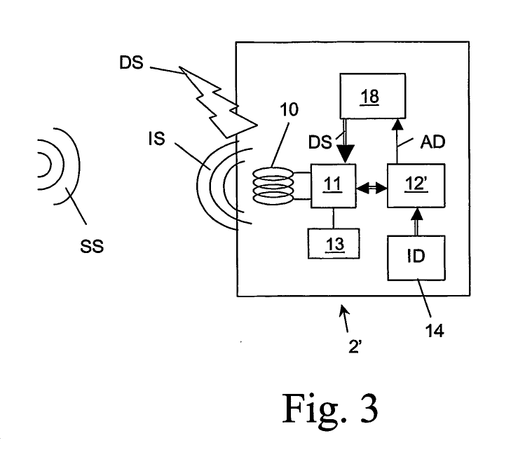

FIG. 3 is a block circuit diagram of a data carrier in accordance with the invention able to be read without physical contact.

FIG. 1 is a block circuit diagram of a so-called RFID system (radio frequency identification system), i.e. a system for contactless communication between a reader and a data carrier. The RFID system comprises a reader 1 and a data carrier 2, which latter is in wireless contact with the reader 1 provided the data carrier 2 is within the zone of action of the reader 1. The reader 1 comprises processing means 3, such as, for example, a microprocessor or microcontroller, which communicate via a data bus with program storage means 4 in which is stored an operating system OS to enable the processing means to perform basic operations, and in which is stored program code, i.e. software, SW to be run in the processing means. The program storage means 4 may be a semiconductor memory such as a PROM, EPROM, EEPROM, etc. It should be mentioned that the processing means and the program storage means may also take the form of ASIC, PAL or the like integrated circuits or devices. The program code SW to be run may also be combined with the operating system to form a program that is confined to rudimentary functions for reading in data from the data carrier 2 and for processing the data that is read in. In the present embodiment the processing means 3 also have a connection for communication purposes to a volatile data memory 5, such as a RAM for example. When running the program code SW, the processing means 3 cooperate with input/output means 8 that may take different forms depending on the design of the reader 1. Merely as an illustration, it will be assumed that the input/output means 8 are in the form of a display to show the data read in from the data carrier 2 to a user of the reader.

To enable the processing means 3 to communicate contactlessly with one or more data carriers 2, the reader 1 has communication means 6 and an antenna 7 connected thereto for transmitting electromagnetic scanning signals. The data carrier 2 can also be supplied with electrical energy with the help of these scanning signals SS, if for example the data carrier 2 is a passive data carrier to standard ISO/IEC 14443. When this is the case, the communication means 6 transmit via the antenna 7 an HF carrier signal of a frequency of 13.56 MHz that carries pulse-width modulated information. The range is typically up to 1 m in the case of this embodiment. To obtain longer ranges, the frequency can be reduced, to 125 kHz for example. With particularly simple RFID systems, the scanning signal emitted by the reader 1 is merely an electromagnetic signal of a given frequency or frequency bandwidth, having a sinusoidal waveform for example. The data carrier in turn is then so arranged that, when it receives sufficient electrical energy from the scanning signal, it changes to an active state in which it continuously transmits permanently stored data, such as an identity number, to the reader. It should be mentioned that the term “high-frequency signals” that is used in the description below for the electromagnetic signals that are transmitted by wireless means is not to be construed as limiting but as referring in general to signals of a frequency of more than approximately 10 kHz. In particular, the term “high-frequency signals” also covers the LF signal frequency band between 30 kHz and 300 kHz, the RF band between 3 MHz and 30 MHz, the UHF band between 300 MHz and 3 GHz and microwaves of above 3 GHz.

In a higher-performance embodiment of the data carrier 2, which is shown in the right-hand part of FIG. 1, the data carrier 2 comprises a coupling element 10 for receiving/transmitting high-frequency signals. The coupling element 10 is implemented in the form of a coil having one or more turns. Connected to the coupling element 10 is an air interface 11 that demodulates the information contained in the scanning signals SS received and modulates information to be transmitted. The air interface 11 also taps off electrical energy from the scanning signal SS received to a voltage supply circuit 13 for supplying voltage to the electrical components of the data carrier 2. The air interface 11 is also connected to a logic circuit 12 that may take the form of a state machine. The logic circuit 12 is connected to a non-volatile memory 14 that contains for example an identity number ID stored in fixed form. When the logic circuit 12 detects among the scanning signals demodulated by the air interface 11 a request from the reader for the identity number ID stored in the non-volatile memory 14 to be read out, it passes said identity number ID to the air interface 11 and the latter transmits this data to the reader in modulated form as a high-frequency identity signal IS.

The data carrier 2 may take a vast variety of different forms, such as a chip card, but may also be incorporated, in a very small form, in articles, such as articles of clothing or banknotes.

To prevent unauthorized reading of the identity number ID stored on the data carrier 2, a jammer referred to in general by reference numeral 20 is provided. In the same way as the data carrier 2, this comprises a coupling element 10 for receiving/transmitting high-frequency signals and an air interface 11 connected to the coupling element 10. Scanning signals emitted by the reader 1 are thus also received by the coupling element 10 of the jammer 20, and the scanning signals SS received are demodulated in the air interface 11. In the same way as has already been explained above by reference to the data carrier 2, the air interface 11 also taps off electrical energy from the scanning signal SS received to a voltage supply circuit 13 for supplying voltage to at least certain electrical components of the jammer 20.

The jammer 20 also comprises analyzing means 15 for analyzing the high-frequency signals received and demodulated by the air interface 11. The analyzing means 15 are arranged to identify scanning signals SS from the reader 1 among the high-frequency signals received, and if such scanning signals SS are detected, to generate a control signal CS that is fed to jamming-signal generating means 18 for generating a jamming signal that are arranged in the jammer, the jamming-signal generating means 18 being arranged, on receiving the control signal CS, to generate a jamming signal DS and beam it out via the air interface 11, in order in this way to jam the reader 1 as a result of the jamming signal DS being superimposed on identity signals IS sent from the data carrier 2 to the reader 1 and error-free reception of these identity signals IS thus being prevented at the reader 1. It is also possible for the data carrier 2 to be jammed by the jamming signals DS so that it does not even emit the identity signal IS. The jamming signal DS is preferably a highly modulated signal or an electromagnetic pulse. Electromagnetic pulses are notable for having a very high harmonic content.

In principle, the entire jammer 20 could be supplied with voltage by the electrical energy that is tapped off by the air interface 11 from the scanning signals SS received and that is treated in the voltage supply circuit 13. The signal strength that is achievable for the jamming signal DS in this case corresponds to that of the identity signals ID emitted by the data carrier 2 but is orders of magnitude less than the signal strength of the scanning signals SS emitted by the reader. Because there is thus no guarantee, under unfavorable conditions (if for example the data carrier 2 is situated considerably closer to the reader than the jammer 20 is), that the jamming signal DS will be superimposed on the identity signal ID in sufficient strength to prevent the latter from being received at the reader, a battery 17 to supply the jamming-signal generating means 18 is also provided in the present embodiment of the jammer 20 to enable a considerably higher signal strength to be obtained for the jamming signal DS. In order on the other hand to ensure that the battery 17 has a long endurance, an electronic switch 16 is provided that is actuated by the analyzing means 15. The analyzing means 15 for analyzing the high-frequency signals received by the air interface are in fact supplied with electrical energy directly from the air interface, or rather the voltage supply circuit 13, as soon as the air interface comes within the zone of action of the reader 1 and thus receives scanning signals SS, from which the requisite energy can be tapped off. As soon as the analyzing means 15 have been activated, they transmit a battery switch-on signal BS to the electronic switch 16, which then closes and remains closed for as long as the jammer remains within the zone of action of the reader 1. The closing of the switch 16 causes the jamming-signal generating means 18 to be supplied with energy from the battery 17.

So that the jammer will respond selectively to only certain types of reader, the analyzing means 15 for analyzing the high-frequency signals received are arranged to detect, from the scanning signals SS, the type of the reader transmitting the scanning signals and to transmit the control signal CS to the jamming-signal generating means 18 only when the type of reader detected is a preset type. The simplest way of detecting the type of the reader is establishing at what frequency the scanning signals are being emitted. For this purpose, the analyzing means 15 may for example be fitted with one or more band-pass filters followed by a comparator.

In a more costly but more accurate embodiment of the analyzing means 15 for analyzing the high-frequency signals received, said means detect commands to the data carrier 2 that are encoded in the scanning signals. The control signal CS is then emitted, and hence the jamming signal is generated and beamed out, either whenever a command is detected or only when certain commands by which the data carrier 2 is requested to read out its data are detected.

So that the user of the jammer 20 is also informed that the jammer has detected and jammed a scanning process by a reader, the jamming-signal generating means 18 are also arranged to emit, in addition, a user warning signal ES. The user warning signal ES may for example be an acoustic signal that is sent out via a mini-loudspeaker 19.

In principle, there are no very detailed limitations on the manner in which the jammer in accordance with the invention may be embodied. It may for example be worn in the clothing or be in the form of a key-fob. In a preferred embodiment of the invention however the jammer is incorporated in a container for holding articles that are provided with data carriers able to be read without physical contact. FIG. 2 shows an embodiment of a container of this kind that takes the form of a wallet or billfold 21. Situated in the wallet 21 is at least one banknote 22 in which a data carrier 2 having a unique identity number is incorporated. The wallet 21 in turn has a jammer 20 in accordance with the invention. It is ensured in this way that the jammer 20 is sufficiently close to the data carrier 2 to reliably jam the latter's transmission of the identity number to a reader.

A block circuit diagram of a data carrier 2′ in accordance with the invention is shown in FIG. 3. In the same way as the data carrier 2 shown in FIG. 1, this data carrier 2′ comprises a coupling element 10 in the form of a coil for receiving/transmitting high-frequency signals. Connected to the coupling element 10 is an air interface 11 that demodulates information contained in scanning signals SS received and that modulates information to be transmitted. In addition, the air interface 11 taps off electrical energy from the scanning signals SS received to a voltage supply circuit 13 for supplying voltage to the electrical components of the data carrier 2′. The air interface 11 is also connected to a logic circuit 12′ that may be implemented in the form of a state machine or microprocessor. The logic circuit 12′ is connected to a non-volatile memory 14 that contains the identity number ID. When the logic circuit 12′ is in a normal mode of operation, it transmits the identity number ID to the air interface ID (which latter transmits this data to the reader in modulated form as a high-frequency identity signal IS) each time it detects among the scanning signals demodulated by the air interface 11 a request from the reader to read out the identity number ID.

The data carrier 2′ may exist in a vast variety of different forms, such as a chip card, but it may also be incorporated, in a very small form, in articles, such as articles of clothing or banknotes.

However, to prevent unauthorized readout of the identity number ID stored in the data carrier 2′, the data carrier 2′ has jamming-signal generating means 18 for generating a jamming signal DS. The jamming-signal generating means may be constructed in a similar way to those of the jammer 20 described above. The logic circuit 12′ further has a jamming mode of operation in which it identifies scanning signals SS from the reader 1 (see FIG. 1) among the electromagnetic signals received and, on detecting scanning signals, transmits an activating signal AS to the jamming-signal generating means 18, the jamming-signal generating means being arranged to generate the jamming signal DS and emit it via the air interface 11 on receiving the activating signal AS. The jamming signal DS is preferably a highly modulated signal or an electromagnetic pulse. The logic circuit 12′ of the data carrier 2′ in accordance with the invention thus comprises the function that is performed by the analyzing means 15 for analyzing the electromagnetic signals received of the jammer that was described above by reference to FIG. 1.

In an illustrative embodiment of the logic circuit 12′, it detects from the scanning signals the type of reader that is emitting the scanning signals and only emits the activating signal AS when the type of reader detected is a preset type, or is not an authorized type. In this way it is possible to prevent the jamming signal DS from being emitted when this is not desired, for example when the data carrier 2′ is within the zone of action of an anti-theft monitoring system in a department store.

In another embodiment of the data carrier 2′ in accordance with the invention, the logic circuit 12′ is arranged to extract commands emitted by the reader from the scanning signals SS and, on detecting commands for the jamming mode to be activated, to go to the jamming mode and, on detecting commands for the jamming mode to be de-activated, to exit the jamming mode. It is possible in this way for the data carrier 2′ to be set selectively to the jamming mode or for said mode to be switched off again. It goes without saying that at least the commands for de-activating the jamming mode must be kept secret or must be protected by encryption when transmitted, to prevent them from being misused to enable unauthorized readers first to switch off the jamming mode of the data carrier and then to read its information.

1. A jammer for jamming the readout of contactless data carriers by a reader emitting electromagnetic scanning signals having an air interface for receiving electromagnetic signals, having analyzing means for analyzing the electromagnetic signals received by the air interface, and having jamming-signal generating means for generating a jamming signal the analyzing means for analyzing the electromagnetic signals received being arranged to identify scanning signals from the reader among the electromagnetic signals received and, when scanning signals are detected, to transmit a control signal to the jamming-signal generating means the jamming-signal generating means being arranged to generate the jamming signal and transmit it via the air interface on receipt of the control signal.

2. A jammer as claimed in claim 1, wherein the air interface is arranged to extract electrical energy to supply the jammer from the signals received.

3. A jammer as claimed in claim 1, wherein a battery is provided to supply the jammer or individual ones of its sub-assemblies with electrical energy, and wherein the battery is preferably able to be switched on as soon as the jammer moves into the zone of action of a reader, and is preferably able to be switched off as soon as the jammer moves out of the zone of action of a reader.

4. A jammer as claimed in claim 1, wherein the analyzing means for analyzing the electromagnetic signals received are arranged to detect the type of the reader emitting the scanning signals from the scanning signals and to emit the control signal only when the type of reader detected is a preset type, or is not an authorized type.

5. A jammer as claimed in claim 1, wherein the analyzing means for analyzing the electromagnetic signals received are arranged to extract from the scanning signals commands to contactless data carriers emitted by the reader and to emit the control signal if commands to data carriers to request them to read out their data are detected.

6. A jammer as claimed in claim 1, wherein the jamming-signal generating means are arranged to generate a highly modulated signal as a jamming signal.

7. A jammer as claimed in claim 1, wherein the jamming-signal generating means are arranged to generate an electromagnetic pulse as a jamming signal.

8. A jammer as claimed in claim 1, wherein the jamming-signal generating means are arranged to emit a user warning signal such as an acoustic or optical signal.

9. A container for holding articles that are provided with data carriers able to be read without physical contact, wherein the container has a jammer as claimed in claim 1.

10. A container as claimed in claim 9 that is in the form of a wallet or billfold a document case or a briefcase.

11. A data carrier able to be read without physical contact by a reader emitting electromagnetic scanning signals, having an air interface for receiving electromagnetic signals, having a logic circuit for analyzing the electromagnetic signals received by the air interface and for transmitting items of information, such as an identity number to the air interface the air interface being arranged to transmit the items of information received from the logic circuit as electromagnetic identity signals and having jamming-signal generating means for generating a jamming signal the logic circuit having a jamming mode of operation in which it identifies scanning signals from the reader among the electromagnetic signals received and, if scanning signals are detected, transmits an activating signal to the jamming-signal generating means the jamming-signal generating means being arranged to generate the jamming signal and transmit it via the air interface on receipt of the activating signal.

12. A data carrier as claimed in claim 11, wherein the logic circuit is arranged to detect the type of the reader emitting the scanning signals from the scanning signals and to emit the activating signal only when the type of reader detected is a preset type, or is not an authorized type.

13. A data carrier as claimed in claim 11, wherein the logic circuit is arranged to extract from the scanning signals commands to contactless data carriers emitted by the reader and to go to the jamming mode of operation if commands to activate the jamming mode of operation are detected and to exit the jamming mode of operation if commands to de-activate the jamming mode of operation are detected.

14. A data carrier as claimed in claim 11, wherein the jamming-signal generating means are arranged to generate a highly modulated signal as a jamming signal

15. A data carrier as claimed in claim 11, wherein the jamming-signal generating means are arranged to generate an electromagnetic pulse as a jamming signal
